(19) United States
(12) Patent Application Publication
(10) Pub. No.: US 2010/0146343 A1
(43) Pub. Date: Jun. 10, 2010

(54) ELECTRONIC BULLETIN BOARD MANAGING APPARATUS AND MESSAGE NOTIFYING METHOD

(75) Inventors: Keiko Shimada, Ichikawa-shi (JP); Akiko Iwashita, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: NTT DoCoMo, Inc., Chiyoda-ku (JP)

(21) Appl. No.: 11/996,645

(22) PCT Filed: Aug. 18, 2006
(86) PCT No.: PCT/JP2006/316230

§ 371 Date: Jan. 24, 2008

(30) Foreign Application Priority Data
Aug. 18, 2005 (JP) 2005-237662

(51) Int. Cl. G06F 15/167; G06F 11/07

(52) U.S. Cl. 714/48; 709/213; 714/E11.025

(57) ABSTRACT

An electronic bulletin board management apparatus and message notification method for permitting a user receiving a notification to quickly know on which bulletin board a message was posted. A communication system includes a message registry for storing data written from a plurality of communication terminals, in memory areas partitioned for the respective communication terminals, and a web server for delivering the stored data in a browsable state in response to a request from a communication terminal. When a piece of data is stored in the message registry by a writing process from one communication terminal, a mail server transmits a notification mail containing notification information to notify that the writing process was done, and a URL to identify a memory area storing the piece of data, in accordance with an instruction from the web server.

### TECHNICAL FIELD

The present invention relates to an electronic bulletin board management apparatus and message notification method for storing messages transmitted from communication terminals.

### BACKGROUND ART

One of the conventional technologies for permitting a user to know an update of contents on an electronic bulletin board without the need for the user to regularly browse the electronic bulletin board is a posting method using the electronic bulletin board as described in Japanese Patent Application Laid-open No. 2002-32297 (Patent Document 1). When a WWW server having the electronic bulletin board described in this Patent Document 1 receives an article to be posted, and a communication address from a communication terminal or the like, it is able to transmit a post-informing e-mail to the contact address. This permits a terminal corresponding to the communication address to be informed that the article was posted on the electronic bulletin board.

[Patent Document 1] Japanese Patent Application Laid-open No. 2002-32297

### DISCLOSURE OF THE INVENTION

### Problem to be Solved by the Invention

In the posting method using the electronic bulletin board described in Patent Document 1, however, the post-informing e-mail contains only a description of information to report the fact of posting. There was, therefore, the problem that the recipient, receiving this post-informing e-mail, was not able to know on which electronic bulletin board the message was posted.

An object of the present invention is therefore to provide an electronic bulletin board management apparatus and message notification method for permitting a user receiving a notification, to quickly know on which electronic bulletin board a message was posted.

### Means for Solving the Problem

In order to solve the above-described problem, an electronic bulletin board management apparatus of the present invention comprises memory means for storing data written from a plurality of communication terminals, in memory areas partitioned for the respective communication terminals; transmitting means for, when a piece of data is stored in the memory means by a writing process from one communication terminal, transmitting transmission information containing notification information to indicate that the data was stored in the memory means, and link information for a link to a memory area storing the piece of data in the memory means, to an arbitrary communication terminal; and delivering means for delivering the data stored in the memory means, so as to be browsable for the arbitrary communication terminal, in response to a request from the arbitrary communication terminal to which the transmitting means transmitted the transmission information.

A message notification method of the present invention comprises a memory step of storing data written from a plurality of communication terminals, in memory areas partitioned for the respective communication terminals; a transmission step of, when in the memory step a piece of data is stored by a writing process from one communication terminal, transmitting transmission information containing notification information to indicate that the data was stored by the memory step, and link information for a link to a memory area storing the piece of data, to an arbitrary communication terminal; and a delivery step of delivering the data stored, so as to be browsable for the arbitrary communication terminal, in response to a request from the arbitrary communication terminal to which the transmission information was transmitted by the transmission step.

According to this invention, when a piece of data is stored by a writing process from one communication terminal, it is feasible to transmit to an arbitrary communication terminal, the notification information to indicate that the writing process was done, and the link information for a link to a memory area storing the piece of data. This permits the user of the arbitrary communication terminal receiving the transmission information to quickly know that the writing process of the message was done and on which electronic bulletin board the message was posted. Therefore, when the user of the communication terminal receives the notification of this writing, the user can quickly browse the written data by sending a delivery request for the written data to the electronic bulletin board management apparatus.

In the electronic bulletin board management apparatus of the present invention, preferably, the transmitting means transmits the transmission information in which an address of the one communication terminal is set as a sender.

According to this invention, the transmitting means is able to transmit the transmission information in which the address of the one communication terminal having performed the writing process is set as a sender, whereby the communication terminal receiving this transmission information can quickly recognize who has performed the writing process.

The transmission information transmitted by the electronic bulletin board management apparatus of the present invention preferably contains state information to indicate an operation state in the electronic bulletin board management apparatus.

According to this invention, the transmission information can be transmitted containing the state information indicating the operation state in the electronic bulletin board management apparatus. For example, where the electronic bulletin board management apparatus functions as a message board for emergency in a time of disaster, the apparatus describes the state information to indicate its state, whether it is functioning for emergency or operating for a test, in the transmission information, whereby the user can know in what state the electronic bulletin board management apparatus is operated.

Preferably, the link information described by the electronic bulletin board apparatus of the present invention is described in an accessible state at the arbitrary communication terminal, and when the arbitrary communication terminal accesses the link information, the delivery means delivers screen data in which items to specify the data browsable for the arbitrary communication terminal, stored in the memory means, are arranged in an accessible state and in a list form, prior to delivering the data stored in the memory means.

According to this invention, the link information is described in the accessible state at the arbitrary communication terminal and, when the arbitrary communication terminal accesses the link information, the delivering means can deliver the screen data in which the items to specify the data browsable for the arbitrary communication terminal are arranged in the accessible state and in the list form. This permits the user of the arbitrary communication terminal to browse any desired data by a simple operation, e.g., by selecting arbitrary data from a list of data stored.

The electronic bulletin board management apparatus of the present invention is preferably configured as follows: it further comprises setting means for storing setting information to indicate whether or not the transmitting means is allowed to function; the transmitting means operates as follows: when the setting information stored in the setting means is such a setting that the transmitting means is allowed to function, the transmitting means execute the transmitting process of transmitting the transmission information; when the setting information stored in the setting means is such a setting that the transmitting means is not allowed to function, the transmitting means transmits error information to indicate an error, to the one communication terminal.

According to this invention, the setting information is stored to indicate whether or not the transmitting process is allowed to function, and when the setting information is set to function the transmitting process, the transmitting process is executed; when the setting information is set not to function the transmitting process, the error information to indicate an error can be transmitted to the one communication terminal. This permits the following operation: when the electronic bulletin board management apparatus is set not to function the transmitting process, the error information to indicate the error is transmitted to the one communication terminal, whereby the user of the one communication terminal as a source of the data can know that no notification is given to the arbitrary communication terminal.

### EFFECT OF THE INVENTION

The present invention enables another user to quickly know on which electronic bulletin board a writing process was done. Therefore, the other user receiving this notification is allowed to quickly browse a message posted.

### BRIEF DESCRIPTION OF THE DRAWINGS

FIG. 1 is a system configuration diagram of communication system 100 according to an embodiment of the present invention.

FIG. 2 is a block configuration diagram of web server 300.

FIG. 3 is an explanatory drawing to illustrate a registration table of messages stored in message registry DB 400.

FIG. 4 is a block configuration diagram of mail server 500.

FIG. 5 is an explanatory drawing to illustrate a specific example of notification mail.

FIG. 6 is screen data (web page) displayed on a mobile terminal.

FIG. 7 is an explanatory drawing to illustrate an address registration table in address registry DB 600.

FIG. 8 is a sequence diagram showing an operation of communication system 100.

### DESCRIPTION OF REFERENCE SYMBOLS

100 communication system; 200 gateway server; 300 web server; 301 communication unit; 302 web-page delivery processor; 303 message registry unit; 304 process determiner; 305 service activation determiner; 400 address registry DB; 500 mail server; 501 mail data generator; 502 mail transmitter; 600 message registry DB; 700 network.

### BEST MODE FOR CARRYING OUT THE INVENTION

The present invention can be readily understood in view of the following detailed description with reference to the accompanying drawings presented for an embodiment. Subsequently, the embodiment of the present invention will be described with reference to the accompanying drawings. The same portions will be denoted by the same reference symbols as much as possible, without redundant description.

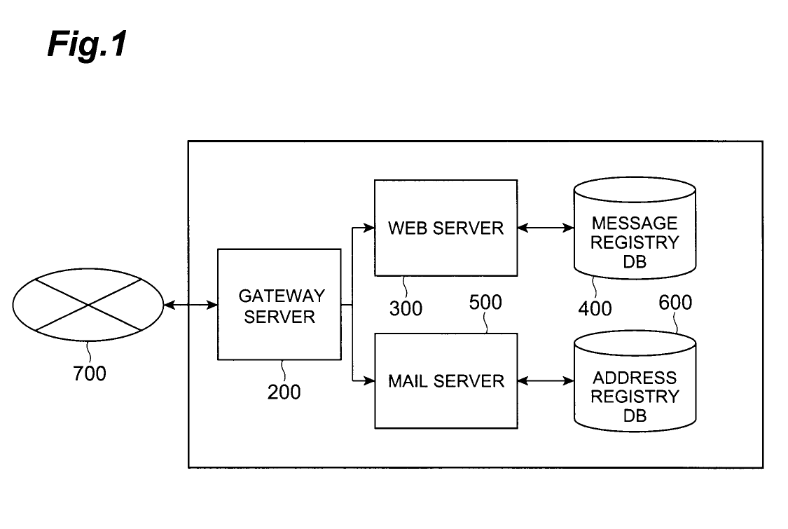

FIG. 1 is a system configuration diagram showing a schematic configuration in communication system 100 being the electronic bulletin board management apparatus of the present embodiment. The schematic configuration of the present embodiment will be described with reference to FIG. 1. The communication system 100 is configured with gateway server 200, web server 300 (delivering means), message registry DB (database) 400 (memory means), mail server 500 (transmitting means), and address registry DB (database) 600.

The gateway server 200 is a server that can be connected to network 700 and that has functions to forward data transmitted via network 700, to web server 300 or to the mail server, and to return a response thereto. When a communication terminal (e.g., mobile terminal) operates to perform a writing process of posting a message on the web server 300, it is connected via the gateway server 200 to the web server 300 and is allowed to perform the writing process of the message.

The web server 300 is a server that has an electronic bulletin board function and that, with a writing process from a communication terminal, stores a written message in message registry DB (database) 400. After the writing process is done, the web server 300 outputs an instruction to instruct the mail server 500 to transmit a notification mail containing notification information to indicate that the writing process of the message was done, and link information for a link to a memory area storing the message (e.g., a URL (Uniform Resource Location)), to a predetermined address or to an address entered upon the writing.

The mail server 500 retrieves an address of a destination from the address registry DB (database) 600, sets the retrieved address as a recipient address, generates a notification mail containing notification information to indicate that the writing process of the message was done, and link information for a link to a memory area storing the message, and transmits the notification mail to the recipient address. When an address is entered upon writing, the mail server 500 generates an e-mail in which the address outputted from the web server 300 is set as a recipient address, without retrieving the address from the address registry DB 600.

In this manner, the e-mail containing the notification information to indicate that the writing process of the message was done, and the link information for a link to a memory area storing the message is transmitted to a mobile terminal (not shown) located on the network 700, via the gateway server 200. In the present embodiment, the gateway server 200, web server 300, and mail server 500 function as an electronic bulletin board management apparatus, but the present invention is not limited to this configuration; for example, it is also possible to adopt a configuration wherein one server having the functions of gateway server 200, web server 300, and mail server 500 is made to function as an electronic bulletin board management apparatus. It is also possible to arrange the web server 300 to perform the function carried out by the mail server 500, e.g., the mail delivery process or the like. In this case the web server 300 operates to acquire the recipient address from the address registry DB 600.

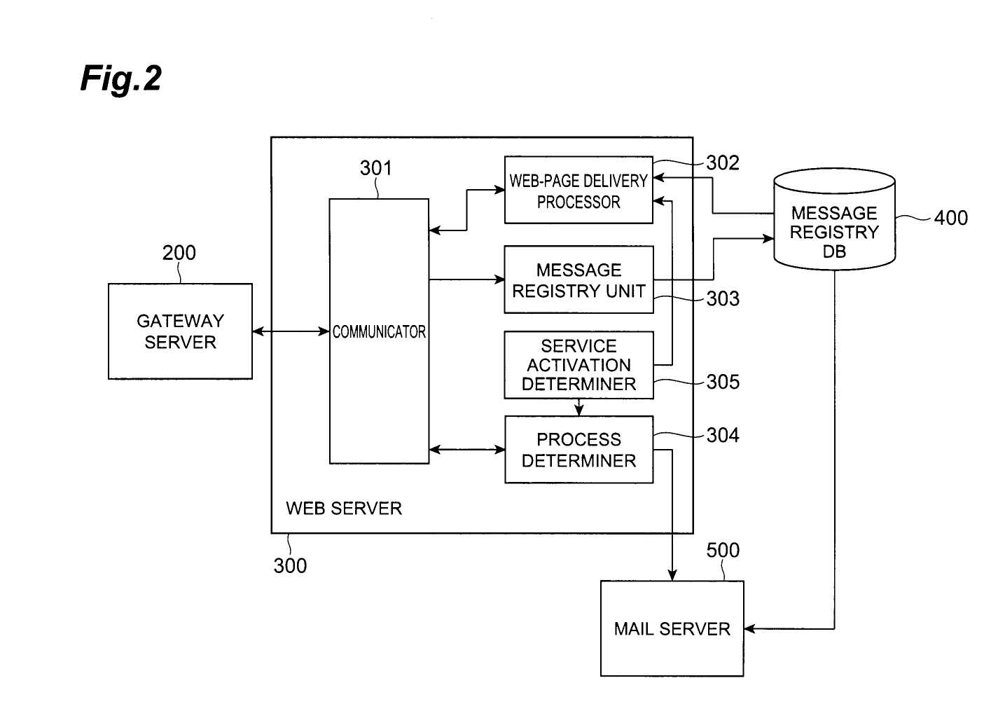

Next, the web server 300 of the present embodiment will be described. FIG. 2 is a block configuration diagram of web server 300. The web server 300 is configured with communication unit 301, web-page delivery processor 302, message registry unit 303, process determiner 304 (setting means), and service activation determiner 305. Each of the components will be described below.

The communication unit 301 is a communicator that transmits or receives data via the gateway server 200. For example, the communication unit 301 is able to transmit or receive data, using HTTP (Hyper Text Transfer Protocol).

The web-page delivery processor 302 is a part that, in response to a delivery request for electronic bulletin board data (e.g., a web page) transmitted from a mobile terminal (not shown), which is received via the communication unit 301, delivers the electronic bulletin board data. The electronic bulletin board data is screen data composed of a web page to accept a message written by a user of the mobile terminal. The web-page delivery processor 302 is able to deliver screen data for confirmation of writing (web page), screen data for selection as to whether the fact of writing is to be notified of (web page), screen data for entry of an address of notification mail (web page), screen data to indicate a list of messages with one address as an address of notification mail (web page), or browsing screen data for browsing a message according to a request from a mobile terminal (web page), in order to function the electronic bulletin board. These pieces of screen data are generated in the web-page delivery processor 302 on the occasion of delivery.

The message registry unit 303 is a part that outputs to the message registry DB 400, a message posted by a writing process on the electronic bulletin board. This message registry unit 303 acquires source information (e.g., a telephone number) to identify a mobile terminal having performed the writing process, from the mobile terminal, and stores the message in correspondence to the acquired source information in the message registry DB 400. The source information used herein does not always have to be limited, particularly, to the telephone number or the like as long as it is personal identification information to uniquely identify a user; it may be a user ID in UIM (User Identity Module) or SIM (Subscriber Identity Module).

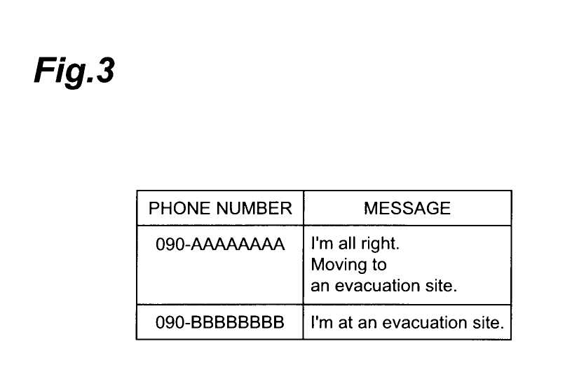

The message registry DB 400 is a part that stores a message received via the web server 300, in correspondence to source information (e.g., a telephone number) being a source of the message, and, specifically, it stores the source information and message outputted from the message registry unit 303, in correspondence to each other. FIG. 3 shows a specific example thereof. FIG. 3 is an explanatory drawing to illustrate a registration table of messages stored in the message registry DB 400. As shown in FIG. 3, the message registry DB 400 stores a telephone number as source information to indicate a source of each message, and the transmitted message in correspondence to each other. The telephone numbers and messages do not always have to be limited only to the one-to-one relation, but the database may also be configured so as to store a plurality of messages for one telephone number.

The message registry DB 400 is configured so that memory areas of messages stored are partitioned for respective mobile terminals as sources, and each memory area is identified by link information (e.g., a URL, a path, or the like) so as to enable a connection from the outside via the network. The database herein stores the telephone numbers to identify the sources, but, without having to be limited to this, the message registry DB 400 may also be arranged to store any other source information to identify the sources, e.g., IP addresses, mail addresses, or the like.

Referring back to FIG. 2, the configuration will be further described. The process determiner 304 is a part that performs processing based on instructions transmitted from mobile terminals. For example, in a case where a message writing process is done on the electronic bulletin board and where the web-page delivery processor 302 transmits to a mobile terminal, screen data (web page) to let a user select whether or not a notification mail containing notification information to indicate storage of the message is to be transmitted, the process determiner 304 performs a process based on an instruction outputted from the mobile terminal by a selected operation to transmit the notification mail. When the process determiner 304 receives the instruction to transmit the notification mail, from the mobile terminal, it outputs instruction information to instruct the mail server 500 to transmit the notification mail. This instruction information contains an instruction to create the notification mail, and link information for a link to a memory area storing the message.

This link information is defined so as to acquire the screen data to indicate a list of messages with one address as an address of the notification mail. The screen data to indicate the list is information created in a list form of source information of messages with one address as an address of the notification mail by the web-page delivery processor 302, based on the correspondence relation between the source information (telephone numbers) stored in the message registry DB 400 and the source information and mail addresses stored in the address registry DB 600.

The process determiner 304 is able to accept address information of the notification mail (e.g., a mail address) via the screen data for entry of an address of the notification mail delivered by the web-page delivery processor 302. When the process determiner 304 accepts the address information of the notification mail, the aforementioned instruction information contains the address information of the notification mail.

The process determiner 304 stores service setting information for configuring a setting to determine whether the notification mail is to be transmitted, and, when the service setting information is set to transmit the notification mail, the process determiner 304 may be arranged to output the instruction information to transmit the aforementioned notification mail, to the mail server 500. This service setting information is set by an operator of the web server 300. When the service setting information is set not to transmit the notification mail, the process determiner 304 transmits an error message to report an error, through the communication unit 301 to the mobile terminal having performed the writing process. The process determiner 304 may also be configured to determine whether the aforementioned notification mail should be transmitted, based on whether the user of the source registered a recipient address.

The service state determiner 305 is a part that determines whether a service is active, and, when the service is not active but functions as a trial version (test), the service state determiner 305 outputs an instruction to instruct the process determiner 304 to add to the notification mail a predetermined character string to indicate that the service is active as a trial version. The process determiner 304 adds an instruction to add the predetermined character string, e.g., a message to indicate that the user is in a trial of a message board for disaster, to the notification mail, into the instruction information.

It is preferable that the electronic bulletin board delivered by the web-page delivery processor 302 according to this processing should also contain a predetermined character string to indicate the fact of the trial version, and, for example, where the setting is configured to indicate that the electronic bulletin board for disaster is functioning, the web-page delivery processor 302 generates the electronic bulletin board data to describe the fact of the electronic bulletin board for disaster, as the electronic bulletin board data to be delivered to the mobile terminal, and delivers it to the mobile terminal. The information to indicate whether the service is in this active state is set by the operator of the web server 300.

As described above, the web server 300 delivers the electronic bulletin board data and stores a message written on the electronic bulletin board data, into the message registry DB (database) 400. When a writing process of a message is done, the web server 300 is able to transmit an e-mail to indicate the fact of writing, together with the link information for a link to a memory area of the message, to a predetermined address or to an address entered upon the writing.

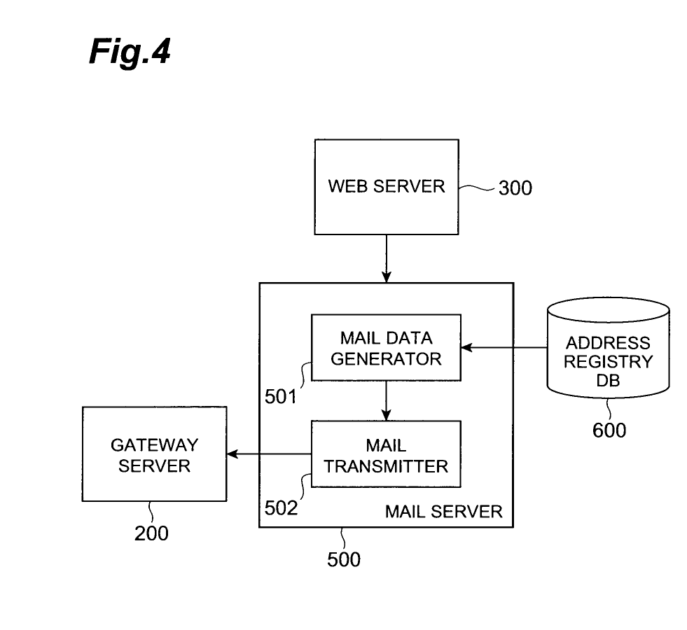

The following will describe the mail server 500. FIG. 4 is a block configuration diagram of mail server 500 of the present embodiment. As shown in FIG. 4, the mail server 500 is configured with mail data generator 501 and mail transmitter 502.

The mail data generator 501 is a part that generates a notification mail containing notification information to notify that a writing process was done on the electronic bulletin board and a message is stored in the web server 300, and link information for a link to a memory area storing the message, based on the instruction information outputted from the process determiner 304. Specifically, the mail data generator 501 extracts the notification information and link information from the instruction information outputted from the process determiner 304, and writes a notification message based on the notification information, and the link information in a main text part of the notification mail. The mail data generator 501 describes a predetermined character string in the notification mail, based on the instruction information outputted from the process determiner 304.

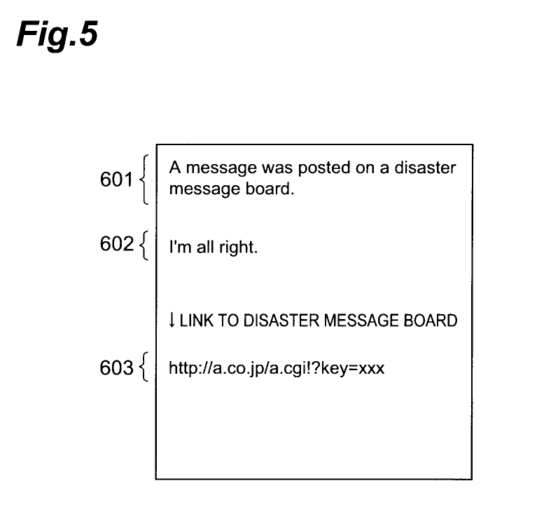

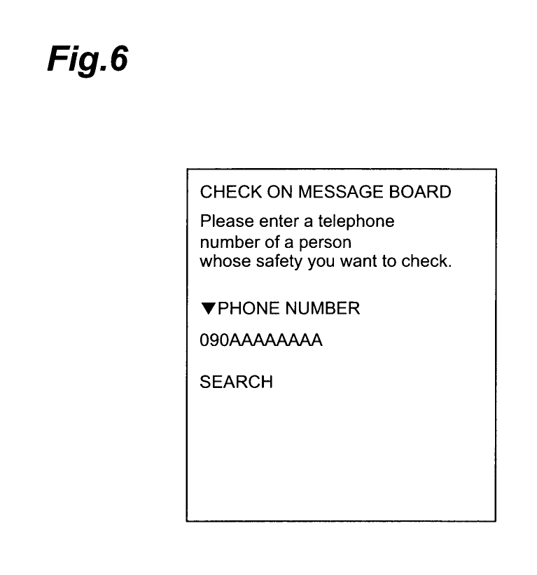

A specific example of this notification mail will be described below. FIG. 5 is an explanatory drawing to illustrate a specific example of the notification mail. As shown in FIG. 5, the notification mail contains descriptions of notification information 601 to indicate the fact of writing of a message, message 602, and link information 603. The link information 603 is, for example, a URL, and is described so as to permit the user to click (or select) the URL and thereby establish an automatic connection to a website indicated by the URL. In the present embodiment, the URL is link information for a link to a memory area storing a message and is, for example, link information that can display the screen data shown in FIG. 6. The message 602 can be omitted.

FIG. 6 is screen data (web page) displayed on a mobile terminal when the link information (URL) shown in FIG. 5 is clicked. As shown in FIG. 6, this screen data is configured so that pieces of source information (telephone numbers) as items to specify mobile terminals having posted a message, and the stored messages are displayed in a list form. Each source information (telephone number) displayed in this list form is described in the screen data so as to permit the user to click (or select) it, and is described to establish a link to a memory area storing a message. The user is allowed to click (or select) any one of the source information indicated in the list form, whereby the user can have a display screen to browse the message corresponding to the source information. Instead of the display in the list form, it is also possible to display only a telephone number of a mail sender to identify a source of a mail.

Referring back to FIG. 4, the configuration of the mail server will be further described. The mail data generator 501 sets a predetermined address or an address designated in a writing process of a message, in a destination part of the notification mail. When the mail data generator 501 generates the notification mail with a predetermined address, it retrieves an address corresponding to the mobile terminal having performed the writing process, from the address registry DB 600 in which addresses are preliminarily registered, and sets the retrieved address as a destination of the notification mail.

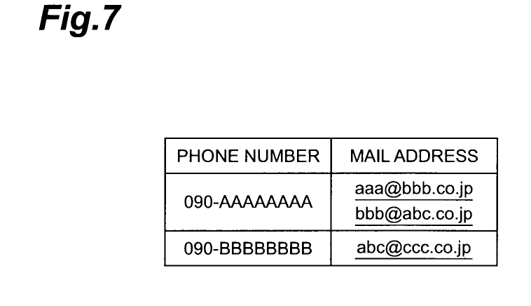

An address registry table stored in the address registry DB 600 will be described below. FIG. 7 is an explanatory drawing to illustrate the address registry table in the address registry DB 600. As shown in FIG. 7, mail addresses being addresses of notification mail are stored in correspondence to telephone numbers being source information to identify mobile terminals having performed the writing process. For example, where the mobile terminal of “090-AAAAAAAA” has performed the writing process, information of a mail address is stored in correspondence thereto in the address registry DB 600 so as to transmit an e-mail to the corresponding mail address, e.g., “aaa@bbb.co.jp.” A plurality of mail addresses may be set in correspondence to one telephone number.

The description will continue referring back to FIG. 4. The mail data generator 501 may be arranged so as to be able to set a mail address of a mobile terminal having performed the writing process of the message, as a sender of the notification mail. In this case, the mail server 500 needs to store a telephone number as source information of the mobile terminal and a mail address of the mobile terminal in correspondence to each other, and then it can specify the mail address of the mobile terminal having performed the writing process of the message, based on the aforementioned correspondence relation by acquiring the telephone number of the mobile terminal having performed the writing process of the message, from the web server 300.

The mail transmitter 502 is a part that transmits the notification mail generated by the mail data generator 501.

As described above, the mail server 500 is able to generate the notification mail and to transmit the notification mail thus generated, to the predetermined address or to the designated address, whereby the recipient can quickly be informed that the message was posted on the electronic bulletin board of the web server 300.

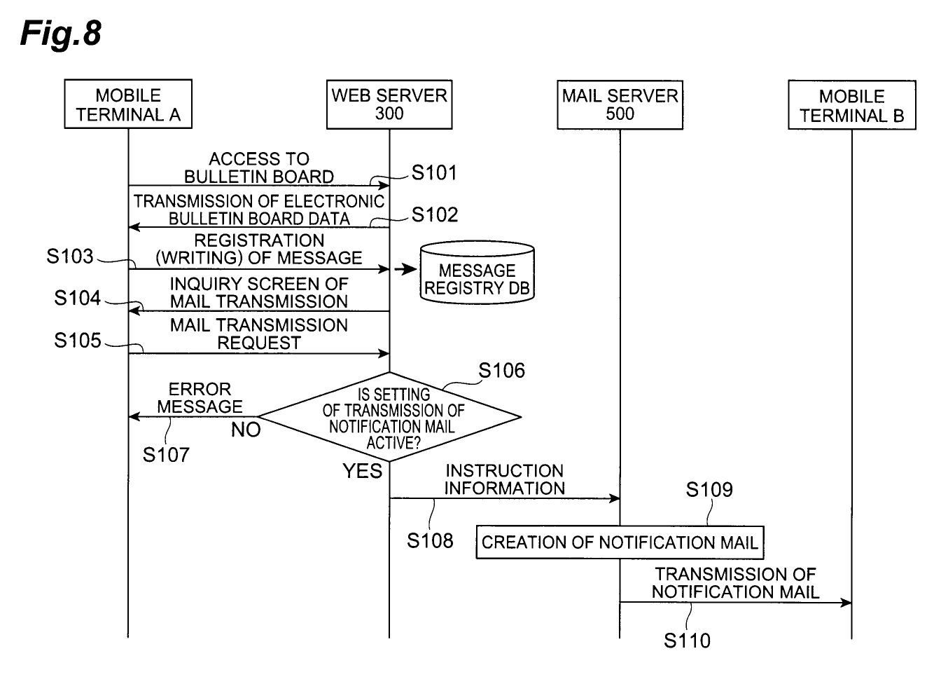

The following will describe an operation of communication system 100 configured as described above. FIG. 8 is a sequence diagram showing an operation of communication system 100 executed when a message is posted on the electronic bulletin board from a mobile terminal and a notification thereof is sent. The processing of the gateway server 200 is omitted.

A mobile terminal A accesses the electronic bulletin board of web server 300 (S101). When the mobile terminal A accesses the electronic bulletin board in the web server 300, the predetermined electronic bulletin board data is transmitted to the mobile terminal A (S102). Then the mobile terminal A transmits a message to the electronic bulletin board to perform a so-called message writing process (S103).

The web server 300 transmits inquiry screen data for letting the user select whether the notification mail to notify that the message was posted is to be transmitted (S104). When execution of mail transmission is selected in the mobile terminal A, a mail transmission request to indicate the selection is transmitted (S105).

When the web server 300 receives the mail transmission request, the process determiner 304 determines whether the service for transmission of notification mail is active (S106). When the process determiner 304 determines herein that the service for transmission of notification mail is not set, the process determiner 304 transmits an error message to the mobile terminal A (S107). When the process determiner 304 determines that the service for transmission of notification mail is set, the process determiner 304 outputs to the mail server 500 the instruction information to instruct it to transmit the notification mail containing the notification information to indicate transmission of the notification mail from the web server 300 and the link information for a link to a memory area storing the message (S108).

When the mail server 500 receives the aforementioned instruction information, the mail data generator 501 generates the notification mail (cf. FIG. 5) containing the notification that the message was posted and stored, and the link information for a link to a storage area storing the message (S109). Then the mail transmitter 502 transmits the notification mail thus generated. Here such a setting that when the mobile terminal A operates to write a message in the web server 300, a mobile terminal B is notified, is supposed. Then the notification mail is transmitted to the mobile terminal B (S110).

On the mobile terminal B, the link information described in the notification mail is clicked by a user operation, whereby the mobile terminal B can acquire screen data (cf. FIG. 6) for a link to the storage area storing the message. Furthermore, when the source information described in the screen data is clicked on the mobile terminal B, the message corresponding to the source information is acquired and displayed.

The above processing permits the following operation: when a message is written in the web server 300, the mail server 500 transmits the notification mail with the descriptions of the notification information notifying that the message was posted, and the link information, to an arbitrary address (a predetermined address or an address entered upon the writing); the mobile terminal receiving this notification mail can be informed that the message was posted on the electronic bulletin board and can quickly access the electronic bulletin board on which the message was posted, to browse the written message.

The following will describe the action and effect of the communication system 100 being the electronic bulletin board management apparatus in the present embodiment.

When a piece of data (message) is stored in the message registry DB 400 by a writing process from one communication terminal (e.g., mobile terminal A), the communication system 100 of the present embodiment is able to transmit the notification mail containing the notification information to indicate that the writing process was done, and the link information for a link to a storage area storing the piece of data, to an arbitrary communication terminal (e.g., mobile terminal B). This permits the user of the arbitrary communication terminal receiving the notification mail, to quickly know that the writing process of the message was done and on which electronic bulletin board the message was posted. Therefore, when the user of the communication terminal receives the notification of the writing, the user can quickly browse the written data by sending a delivery request for the written data to the web server 300.

The mail transmitter 502 of the mail server 500 in the communication system 100 is able to transmit the notification mail in which the address of the one communication terminal having performed the writing process is set as a sender, and the communication terminal receiving this notification mail can quickly recognize who sent the information.

The mail transmitter 502 of the mail server 500 in the communication system 100 is able to transmit the notification mail containing the state information to indicate an operation state of the electronic bulletin board of the web server 300. For example, where the electronic bulletin board functions as a message board for emergency in a time of disaster, the state information to indicate its state, whether the board is functioning as one for emergency or operating as a test, can be described in the notification mail, whereby the user can know in what state the electronic bulletin board is operated.

In the communication system 100, the link information (e.g., URL) is described so as to enable access from an arbitrary communication terminal, and when the arbitrary communication terminal accesses the link information, the web-page delivery processor 302 can deliver the screen data in which items to specify data browsable for the arbitrary communication terminal are arranged in an accessible state and in a list form. It is also possible to display only a telephone number of a mail sender to identify a sender of mail. This permits the user of the arbitrary communication terminal to browse any desired data by a simple operation, e.g., by selecting arbitrary data from a list of stored data.

In the communication system 100 the process determiner 304 of the web server 300 is configured to store the setting information to indicate whether the transmitting process of notification mail is set to function; when the setting information is that the transmitting process is set to function, the process determiner 304 executes the transmitting process; when the setting information is that the transmitting process is set not to function, the process determiner 304 transmits the error information to indicate an error, to the one communication terminal. For example, the process determiner 304 can determine whether the aforementioned notification mail is to be transmitted, based on whether the user of the source registered a recipient address. This permits the following operation: when the transmitting process of notification mail is set not to function, in the electronic bulletin board, the error information to indicate an error is transmitted to the one communication terminal, whereby the user of the one communication terminal as a source of data can be informed that no notification is sent to an arbitrary communication terminal, and thus the electronic bulletin board easier to use is operated.

1-6. (canceled)

7. An electronic bulletin board management apparatus comprising:
a memory for storing data written from a plurality of communication terminals, in memory areas partitioned for the respective communication terminals;
a transmitting unit for, when a piece of data is stored in the memory by a writing process from one communication terminal, transmitting transmission information containing notification information to indicate that the data was stored in the memory, and link information for a link to a memory area storing the piece of data in the memory, to an arbitrary communication terminal; and
a delivering unit for delivering the data stored in the memory, so as to be browsable for the arbitrary communication terminal, in response to a request from the arbitrary communication terminal to which the transmitting unit transmitted the transmission information.

8. The electronic bulletin board management apparatus according to claim 7, wherein the transmitting unit transmits the transmission information in which an address of the one communication terminal is set as a sender.

9. The electronic bulletin board management apparatus according to claim 7, wherein the transmission information contains state information to indicate an operation state in the electronic bulletin board management apparatus.

10. The electronic bulletin board management apparatus according to claim 7, wherein the link information is described in an accessible state at the arbitrary communication terminal, and
wherein when the arbitrary communication terminal accesses the link information, the delivery unit delivers screen data in which items to specify the data browsable for the arbitrary communication terminal, stored in the memory, are arranged in an accessible state and in a list form, prior to delivering the data stored in the memory.

11. The electronic bulletin board management apparatus according to claim 7, further comprising a setting unit for storing setting information to indicate whether or not the transmitting unit is allowed to function,
wherein the transmitting unit operates as follows:
when the setting information stored in the setting unit is a setting that the transmitting unit is allowed to function, the transmitting unit executes the transmitting process of transmitting the transmission information;
when the setting information stored in the setting unit is a setting that the transmitting unit is not allowed to function, the transmitting unit transmits error information to indicate an error, to the one communication terminal.

12. A message notification method comprising:
storing data written from a plurality of communication terminals, in memory areas partitioned for the respective communication terminals;
transmitting, when in the storing a piece of data is stored by a writing process from one communication terminal, transmission information containing notification information to indicate that the data was stored by the storing, and link information for a link to a memory area storing the piece of data, to an arbitrary communication terminal; and
delivering the data stored, so as to be browsable for the arbitrary communication terminal, in response to a request from the arbitrary communication terminal to which the transmission information was transmitted by the transmitting.
